(19) United States
(12) Patent Application Publication
(10) Pub. No.: US 2002/0139886 A1
(43) Pub. Date: Oct. 3, 2002

(54) Fishing reel

(75) Inventor: Wataru Tsutsumi, Saitama (JP)

Correspondence Address: SUGHRUE MION, PLLC, 2100 Pennsylvania Avenue, NW, Washington, DC, 20037-3213, US

(73) Assignee: DAIWA SEIKO, INC.

(21) Appl. No.: 10/078,264

(22) Filed: Feb. 20, 2002

(30) Foreign Application Priority Data
Feb. 20, 2001 (JP) P2001-042823

(51) Int. Cl. A01K 89/00

(52) U.S. Cl. 242/316

(57) ABSTRACT

The invention is to offer a fishing reel having a leg portion effecting little load for a long time, enabling to grasp and hold stably, and being easy to grip with good fitness under the condition of holding together with the fishing rod. The fishing reel has a leg portion which is formed at an upper part thereof with a rod holding portion detachable with a fishing rod, and the leg portion has an exterior shape asymmetrical in cross section in a longitudinal direction of the fishing rod. The leg portion has a bulge portion expended toward a rod tip of the fishing rod so as to form the asymmetrical exterior shape.

### BACKGROUND OF THE INVENTION

The present invention relates to a fishing reel provided with a leg portion to be held with a fisherman's hand fingers together with a fishing rod under a condition where the fishing reel is attached to the fishing rod.

Generally, this kind of fishing reels (for example, a fishing spinning reel) are attached and fixed to the fishing rod at a rod holding portion of the upper part of the leg portion, and are integrally attached to the fishing rod. When a fisherman holds the leg portion with the fishing rod, the leg portion is grasped by holding it between, for example, a third finger and a middle finger or a third finger and the little finger.

The respective fingers grasping the leg portion together with the fishing rod are oblique with respect to the leg portion 2, for example, as seen in FIG. 3A. Specifically, respective nail tips of fingers orient backward (a rod base side) in a length direction of the fishing rod (a direction from the rod base toward a rod tip side). An exterior shape of the general leg portion 2 is, as seen in FIG. 3B, symmetrical back and forth, right and left, and in a diagonal direction, in case of viewing the cross section of the leg portion 2.

The fingers holding the leg portion 2 is brought in to contact with the leg portion 2 at different parts of the fingers.

Therefore, the finger contacting conditions are not stable and 5 always unstable. As a result, not only the grasping is hard and the holding is insufficient, but also excess load is effected to the fingers grasping the leg portion 2 and the fingers are not durable to a fishing for a long time.

### SUMMARY OF THE INVENTION

The invention has been made for solving these problems, and it is an object of the invention to offer a fishing reel having a leg portion effecting little load for a long time, enabling to grasp and hold stably, and being easy to grip with good fitness under the condition of holding together with the fishing rod.

For accomplishing the object, a fishing reel of the invention is characterized by comprising a rod holding portion detachable with a fishing rod, and a leg portion, the holding portion being formed at one end thereof, wherein the leg portion has an exterior shape asymmetrical in a longitudinally direction of the fishing rod.

Namely, noting the obliquity of the fingers when gripping the reel together with the fishing rod, the leg portion is formed such that the exterior view is made asymmetrical in the length direction for improving easiness in gripping.

### BRIEF DESCRIPTION OF THE DRAWINGS

FIG. 1 is a view showing the exterior view of the fishing spinning reel according to an embodiment of the invention;

FIG. 2A is an enlarged view of the portion of the leg portion; and FIGS. 2B to 2E are the cross sectional views showing the variations of the leg portions expanding the rod tip sides with respect to the center X of the leg portion; and

FIG. 3A is a view showing the conditions of the fingers gripping the leg portion together with the fishing rod in the existing fishing reel. FIG. 3B is a cross sectional view of the leg portion of the related fishing reel.

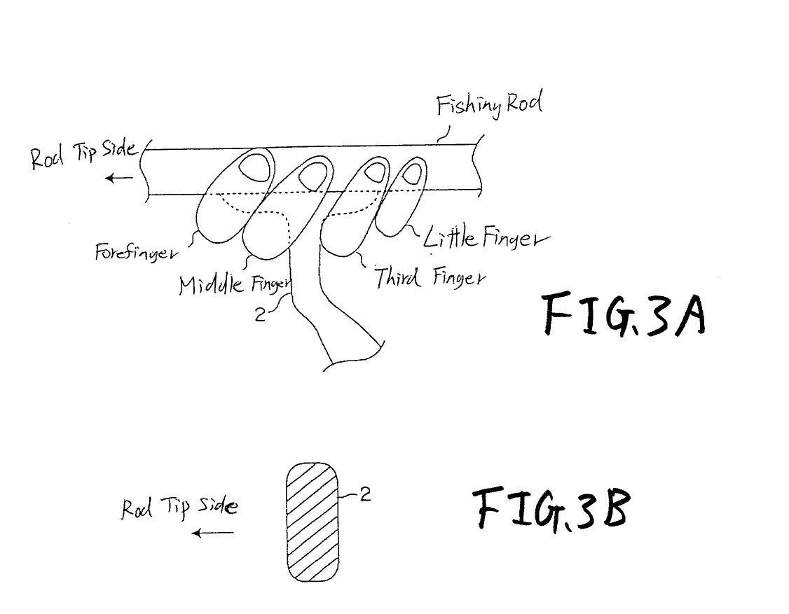

### DETAILED DESCRIPTION OF PREFERRED EMBODIMENTS

A description will be made to the fishing reel according to an embodiment of the invention with reference to the drawings, and a fishing spinning reel is employed so as to describe the embodiment of the invention.

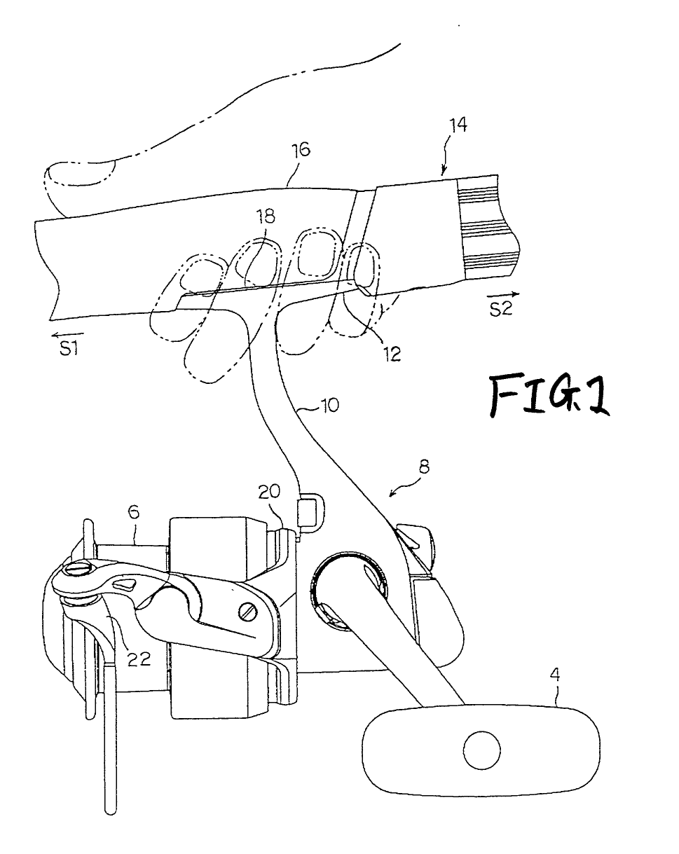

As illustrated in FIG. 1, in the fishing spinning reel according to the embodiment, a handle 4 and a spool 6 are built in a reel body 8, and a leg portion 10 extends from the reel body 8 and is provided at an upper part with a rod holding portion 12 elongating back and forth. The rod holding portion 12 is attached and fixed to a fishing rod 14, whereby the reel body 8 can be integrally attached to the fishing rod 14. Specifically, the fishing rod 14 is provided with a grip 16 to be held by a fisherman's fingers, and the grip 16 has a mounting portion 18 on which the rod holding portion 12 is mounted. If fixedly attaching the rod holding portion 12 to the mounting portion 18, the reel body 8 is integrally attached to the fishing rod 14. In the drawings, a rod tip side is shown with S1 and a rod base side is shown with S2.

After the reel body 8 is attached to the fishing rod 14, a fishing operation (casting, drawing and reeling a fishing line) is carried out under a condition where the fishing rod 14 and the leg portion 10 are supported by the fisherman with his hands and fingers. For example, when reeling the fishing line and rotating the handle 4, the rotation of the handle is transmitted to a pinion via a driving gear and drive the pinion. At the same time, the rotation is transmitted to a spool axis via an oscillating mechanism and moves the spool axis back and forth. At this time, when the spool 6 moves back and forth while a rotor 20 rotating, the fishing line is evenly reeled through a fishing line guide 22 without biasing to the spool 6.

The present embodiment realizes such a leg portion 10 effecting little load for a long time, enabling to grasp and hold stably, and being easy to grip with good fitness under the condition of holding the fishing rod 14 and the leg portion 10 at the time of the fishing operation.

The leg portion 10 according to the embodiment has the exterior shape asymmetrical in a longitudinal direction of the fishing rod 14. In this case, the longitudinal direction is defined by a direction from the rod base side S2 to the rod tip side S1. The exterior shape is a contour when viewing the leg portion 10 from the outside and is a notion including a cross sectional shape along V-V line of the leg portion 10.

“Asymmetrical” is meant in that the exterior shape of the leg portion 10 is not symmetrical back and forth, right and left, and in the diagonal direction with respect to the longitudinal direction of the fishing rod 14. Herein, “back and forth” is a notion defining that the rod tip side S1 is front and the rod base side S2 is back. “Right and left” is a notion defining the right and left directions when viewing the rod tip side S1 from the rod base side S2 in the longitudinal direction of the fishing rod 14. The “diagonal direction” is a notion defining the diagonal positions with respect to the cross sectional center of the leg portion 10 under the condition defining the “back and forth” and “right and left”.

As the specific exterior shape of the leg portion 10, the leg portion 10 according to the embodiment takes the asymmetrical exterior shape having a bulge portion at a front side (i.e., the rod tip side S1) with respect to the center X of the leg portion. The bulge portion is formed by expanding the front side of the leg portion toward the rod tip side. In this case, the center X of the leg portion is defined with a position (the center divided with the length m) halving a full length 2 m in the length direction of the rod holding portion 12.

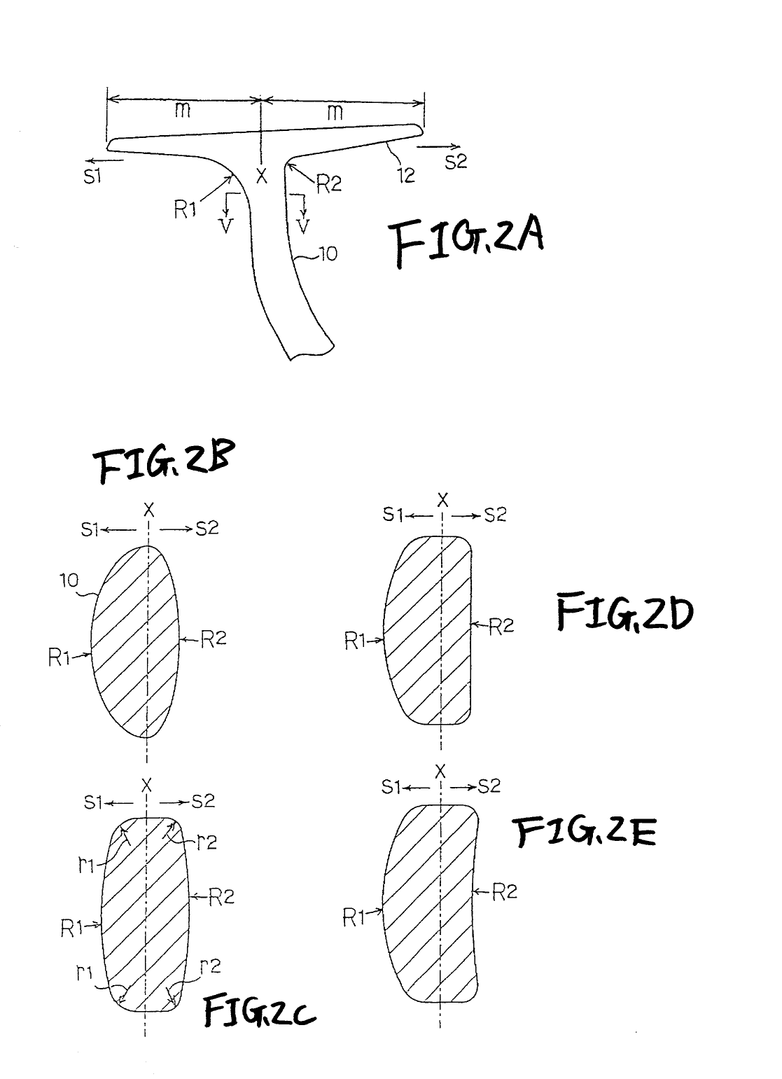

FIGS. 2B to 2E show variations of the leg portion 10 according to the embodiment which respectively have bulge portions expanded from the leg portion at the rod tip sides S1 with respect to the center X of the leg portion. FIGS. 2B to 2E show cross sectional views along V-V line (see FIG. 2A) of the leg portions 10.

The leg portion 10 shown in FIG. 2B is almost oval having bulge portions at both of the rod tip side S1 and the rod base side S2 with respect to the center X of the leg portion. Specifically, for increasing the bulge amount of the rod tip side S1, a bulging curvature R1 of the rod tip side S1 is determined to be smaller than a bulging curvature R2 of the rod base side S2 with respect to the center X of the leg portion.

The leg portion 10 shown in FIG. 2C is almost oval having bulge portions at both of the rod tip side S1 and the rod base side S2 with respect to the center X of the leg portion. In this example, the bulging curvature R1 of the rod tip side S1 and the bulging curvature R2 of the rod base side S2 are determined to be smaller than that of the leg portion 10 of FIG. 2B with respect to the center X of the leg portion. The curvatures of four corners in the diagonal directions are asymmetrical with respect to the center X of the leg portion. Specifically, for increasing the bulge amount of the rod tip side S1, a curvature r1 of the rod tip side S1 is determined to be larger than the curvature r2 of the rod base side S2 with respect to the center X of the leg portion.

The leg portion 10 shown in FIG. 2D has only one bulge portion at the rod tip side S1 with respect to the center X of the leg portion. Specifically, the bulge portion of the rod tip side S1 is expanded at a predetermined bulging curvature R1 with respect to the center X of the leg portion, and on the other hand, the bulge curvature R2 of the rod base side S2 is set to be almost zero so as to be substantially flat.

The leg portion 10 shown in FIG. 2E has the bulge portion at the rod tip side S1 with respect to the center X of the leg portion and a recess portion at the rod base side S2. Specifically, the bulge portion of the rod tip side S1 is expanded at the predetermined bulging curvature R1 with respect to the center X of the leg portion, and on the other hand, the recess portion of the rod base side S2 is curved at the predetermined curvature R2.

Thus, when expanding the rod tip side S1 with respect to the center X of the leg portion, it is possible to realize the leg portion 10 effecting little load for a long time, enabling to grasp and hold stably, and being easy to grip the fishing rod 14 with good fitness under the condition of holding together with the fishing rod 14.

The exterior shape of the leg portion 10 according to the invention is not limited to the respective curvatures R1, R2, r1 and r2 seen in FIGS. 2B to 2E. In response to shapes, dimensions of the fishing reels, users' needs or using purposes, these curvatures may be varied appropriately or adjusted for composing the exterior shape.

Since the respective curvatures R1, R2, r1 and r2 should not be decided in one type, its dimension and value may be varied appropriately or adjusted in response to shapes, dimensions of the fishing reels, users' needs or using purposes.

According to the invention, it is possible to offer a fishing reel having a leg portion effecting little load for a long time, enabling to grasp and hold stably, and being easy to grip with good fitness under the condition of holding together with the fishing rod.

What is claimed is:

1. A fishing reel comprising:
a rod holding portion detachable with a fishing rod; and
a leg portion, the holding portion being formed at one end thereof, wherein the leg portion has an exterior shape asymmetrical in a longitudinally direction of the fishing rod.

2. The fishing reel according to claim 1, wherein the leg portion has a bulge portion expended toward a rod tip of the fishing rod so as to form the asymmetrical exterior shape.
